(19) United States
(12) Patent Application Publication
(10) Pub. No.: US 2023/0073717 A1
(43) Pub. Date: Mar. 9, 2023

(54) Systems And Methods For Electronic Surveillance

(71) Applicant: Selex ES Inc., Greensboro, NC (US)

(72) Inventor: Todd Child, Greensboro, NC (US)

(21) Appl. No.: 17/940,546

(22) Filed: Sep. 8, 2022

Related U.S. Application Data
(60) Provisional application No. 63/242,141, filed on Sep. 9, 2021.

(51) Int. Cl. G06V 20/52; G06V 10/80; G06V 20/62; G06F 16/9537

(52) U.S. Cl. CPC G06V 20/52; G06V 10/803; G06V 20/625; G06F 16/9537; G06V 2201/08

(57) ABSTRACT

A system and method to identify and correlate identifying information or signatures with one or more targets of interest. The system may include a plurality of collection systems to capture information related to visual identifiers and/or electronic signatures associated with targets in selected locations. The system may further include an intelligence system to determine a target of interest based on the information related to visual identifiers and/or electronic signatures and to track the target of interest.

### CROSS REFERENCE

The present patent application claims the benefit of U.S. Provisional Application No. 63/242,141, filed Sep. 9, 2021.

### INCORPORATION BY REFERENCE

The disclosures made in U.S. Provisional Application No. 63/242,141, filed Sep. 9, 2021, are specifically incorporated by reference herein as if set forth in their entirety.

### TECHNICAL FIELD

In one aspect, the present disclosure is directed to surveillance systems and methods, and more specifically, to surveillance systems and methods that facilitate collection and correlation of electronic signatures and/or visual identifiers for targets or convoys. Other aspects also are described.

### BACKGROUND

Automated License Plate Readers (“ALPR”) typically are used for identifying vehicles in selected locations, e.g., for detecting traffic violations, collecting tolls, etc. . . . . However, existing ALPR systems are quite expensive and generally are used for identification of vehicles on roads, in parking lots, other vehicle throughways, etc. . . . . Existing ALPR systems further generally are not used for identification and/or tracking of persons separately from their vehicles. In addition, these systems may have difficulty determining who is driving or is a passenger in any given vehicle.

It can be seen that a need exists for surveillance systems and methods that can be used in conjunction with or in place of existing ALPR systems to provide for more precise, reliable, and/or consistent identification or tracking of vehicles, as well as persons associated with, and not associated with, vehicles.

The present disclosure is directed to the foregoing and other related, and unrelated, problems in the relevant art.

### SUMMARY

Briefly described, the present disclosure is directed to surveillance systems and methods for collecting and correlating electronic signatures and/or visual identifiers via artificial intelligence, machine learning models or classifiers, and/or Big Data techniques to build intelligence databases that can be configured and updated to facilitate tracking and association of indicators of common locations and movements of targets throughout selected geographic areas or locations. The term “targets” generally refers to persons, vehicles, e.g., an automobile or other vehicle, or both, such a one or more persons within a vehicle. However, targets can include other objects, such as one or more electronic devices, e.g., cell phones or other communication devices, RFID and other sensors or transmitting devices that can be removed from and/or separate from a vehicle and/or can be internal to vehicles or as after-market additions, and/or various other, similar devices, without departing from the scope of the present disclosure.

According to aspects of the present disclosure, a surveillance system is provided, which includes collection systems or assemblies, and an intelligence system having classification and search capabilities. In embodiments, the surveillance system will use the characteristics of the collected identifying characteristics to prioritize or otherwise indicate to an investigator that a particular characteristic is material to the identification of the target of an investigation.

In embodiments, a method is provided that can use correlation statistics and analysis to develop relationships between identifiers and non-unique characteristics over multiple encounters. No single factor is required to be an absolute or unique identifier. One or more combinations of non-unique characteristics and broadcast or visible variables, methods and transmitted values can be used to identify a set that are collectively statistically significant in their unique association with the source entity. In embodiments, this method uses artificial intelligence and “Big Data” techniques to identify correlations and to rank those results based on statistical methods created in expert noise reduction and confidence analysis.

In embodiments, the surveillance system can include a plurality of collection systems or assemblies that are located at selected geographic areas or locations. The collection systems generally are configured to capture or facilitate collection of information related to visual identifiers or electronic signatures associated with targets in or moving about the selected areas/locations.

In some embodiments, the collection systems can include at least one sensor configured to collect or otherwise capture information related to visual identifiers and/or electronic signatures of targets. The visual identifiers can include visual vehicle identifiers, such as license plate information or other visual or imaged information associated with vehicles (e.g., stickers, patterns, position(s) of component parts, after-market added parts, damage, and/or various other markings, etc. . . . ) that can be used to distinguish or otherwise identify, detect or discern a target vehicle, etc. . . . . The electronic signatures can include an electronic signal or combination(s) of electronic signals emanating from transmitting electronic devices, and which are associated with and/or can uniquely identify the targets in or moving about the selected areas/locations.

In addition, in some aspects, the surveillance system can include an intelligence system that is in communication with the plurality of collection systems. The intelligence system will be configured to receive the information collected or captured by the collection systems (e.g., data points or packets of time and date stamped information in real time when targets get within proximity of the collection point systems), and will further be configured (e.g., including programming, etc.) to identify and/or track the targets based on this received information.

In embodiments, the intelligence system can include classification and search capabilities, for example, including one or more correlation and search engines and an intelligence database in communication therewith. The one or more correlation and search engines can be configured to identify or extract the electronic signatures associated with the targets using the information collected by the collection systems and catalogue them in the intelligence database with certain identifying characteristics (e.g., geographical coordinates, time stamps, source manufacturer, source type and unique ID, etc.) allowing these identified electronic signatures to become unique, identifiable, and searchable.

The surveillance system thus is configurable to track, map, catalogue, etc., movements of the targets in real time as electronic signals emanating therefrom occur in proximity to the collection systems. The tracking information generated can be used to help confirm and/or authenticate a potential target identification, and further can be configured to generate alerts or notifications when certain targets are in proximity to the collection systems.

The one or more correlation and search engines can develop inferences of relationships between electronic devices and targets based on consistency and/or frequency of detected correlations between identified/extracted electronic signatures being associated with targets.

For example, the one or more correlation and search engines can use frequency and consistency of electronic signals to determine the relative certainty of association of the transmitted electronic devices and targets to develop electronic signatures of the targets. That is, if the relative certainty or probability that a certain electronic signal or combination of electronic signals are associated with a target meets a prescribed threshold, the one or more correlation and search engines can identify an electronic signal or combinations of electronic signals as a specific electronic signature associated with that target. Further, the one or more correlation and search engines can use frequency and consistency of captured images of different targets traveling together to develop a correlation between different targets. That is, if the relative certainty or probability that a certain first target travels with a second target meets a prescribed threshold, the one or more correlation and search engines can identify one or more targets, e.g., first and second targets and/or others, as associated with a convoy. The term “convoy” generally refers to a group of or two or more targets that travel together one or more times on one or more days (e.g., two vehicles that travel together at a specific time on various days).

In an embodiment, the one or more correlation and search engines will be configured to correlate one or more identifying characteristics and/or non-unique characteristics over multiple encounters. The one or more identifying characteristics may include license plates, electronic signals, and/or visual idiosyncrasies, among other factors. Non-unique characteristics may include vehicle make, vehicle model, vehicle color, vehicle year, among other non-unique characteristics. Such correlations may be determined via machine learning models or classifiers and/or statistical modeling or analysis. The one or more correlation and search engines may utilize such correlations to determine various aspects of a target, such as a vehicle's location at a specific time and/or place, association to specific persons, association to locations, and/or travel patterns, among other aspects. Further, the one or more correlation and search engines may be utilized to determine statistically significant correlations or associations between targets and/or electronic signals.

In an embodiment, the one or more correlation and search engines will be configured to analyze correlation results using frequency of occurrence, relative representation, signal type, signal receipt location diversity, and signal strength profiling to generate and present confidence levels and/or rankings for correlations between signal-receipt events. The one or more correlation and search engines may be configured to filter and sort results such that the user is directed to signals most likely to have originated from the same set of targets and/or devices travelling together.

In an embodiment, the systems and methods may include filtering in-coming electronic signals to maximize the receipt and storage of moving, stable, identifiable signals by analyzing the signal value, strength, spectrum, and embedded identification data. The systems and method may also simultaneously reduce and filter signals and identifiers that are ‘noise’ from likely-unrelated sources and not relevant to the future correlation.

In addition, or in the alternative, the one or more correlation and search engines will be configured to associate or correlate identifying electronic signatures with visual identifiers, such as a visual vehicle identifier, to allow independent tracking and location identification of targets based on the associated identifying electronic signatures. That is, once the system has records correlating electronic signatures associated with a specific visual vehicle identifier, e.g., a specific license plate number, the intelligence system will be able to detect the likely presence of a vehicle and its associated license plate without visual information, e.g., without the use of a camera. Further, correlation between two or more targets may allow dependent tracking and location identification of targets based on associated or correlated one or more targets. That is, once the system has records correlating a first target with a second target (or more targets), the intelligence system will be able to determine likely presence of the first target based on visual information and/or electronic signals of the second or more targets.

Furthermore, the collection systems can be placed in locations or areas not associated with vehicular traffic, such that the intelligence system will be able to identify, and catalogue known electronic signatures away from the vehicles they have typically been associated with, e.g., for tracking, mapping, etc. of persons or electronic devices apart from vehicles.

In embodiments, the at least one sensor of each collection system can include a plurality of sensor assemblies. The sensor assemblies can include one or more cameras or camera systems configured to capture or facilitate collection of information related to vehicle identifiers, such as visual information related to a license plate of a vehicle or other visual vehicle identifiers.

In addition, the sensor assemblies can include one or more antennas or other signal receivers configured to capture information related to the electronic signatures. The one or more antennas can include a plurality of antennas, such as a Bluetooth® antenna, a Wi-Fi antenna, a RFID antenna, or other RF antennas or combinations thereof, configured to capture information related to electronic signals associated with the targets.

In some embodiments, the collection systems can be used in conjunction with Automated License Plate Readers (“ALPR”) in certain areas, allowing the intelligence system to develop a subset of electronic signals, i.e., an electronic signature, associated with a license plate read at a moment in time and location. Electronic data points from less expensive collectors can then be used to provide more precise tracking than ALPR alone.

In some embodiments, the surveillance system can be configured to capture sample electronic signature information from a target and/or visual identifiers of other targets, associate that information with the target's identification, and then search for or alert on receipts of similar electronic signature information at one of the collection point systems.

In additional embodiments, the surveillance system can be configured to allow for search inquiries or scans of suspect's electronic signatures to search known location data points in the database history, placing the suspect at those locations and times. In such examples, the surveillance system can include a user interface. A user can access the user interface and provide various inputs into the user interface. The inputs may include one or more of time, location, license plate numbers, partial license plate numbers, and/or data related to a witness statement or the actual witness statement. In an embodiment, the user may input, as noted, a witness statement. In such examples, the surveillance system may include text recognition algorithms to parse through the witness statement and separate out important or key words, such as identifying characteristics. Upon providing the various inputs, the surveillance system may provide, as an output, information correlated to the various inputs. For example, an input may include a time, a location, and a portion of a license plate. The output may include how often a vehicle with the portion of the license plate is at that location. Such an output may be determined, at least in part, based on the correlation between that vehicle and other vehicles, electronic data signals, and/or people.

In still other embodiments, the surveillance system can be configured to allow for labeling of specific electronic signatures with a target and then alert or search for history of those specific electronic signatures in the database, placing the target at various locations.

In further embodiments, the surveillance system further can indicate or determine changes in association or travel of suspects or other individuals of interest based on variations in electronic signatures and/or correlated targets associated with a target or targets.

In aspects, a surveillance system is provided, comprising: a plurality of collection systems positioned at selected geographic areas, each comprising one or more sensors configured to capture visual identifiers for each of a plurality of targets; and one or more sensors configured to capture electronic signals associated with the plurality of targets; and an intelligence system in communication with each of the plurality of collection systems, the intelligence system including a correlation and search engine configured to: receive captured visual identifiers for each target of the plurality of targets, and captured electronic signals associated with each target of the plurality of targets from each of the plurality of collection systems; filter the captured electronic signals associated with each target in view of one or more non-unique characteristics of the captured electronic signals and develop at least one electronic signature associated with each target; correlate the captured visual identifiers for each target with at least one electronic signature associated with the target; and generate an identification of one or more unknown targets based prior known factors associated with the target; determine a location of a selected target, determine an association of the selected target to one or more persons, determine an association of the target to one or more locations, travel patterns of the selected target, or combinations thereof; or combinations thereof.

In embodiments of the surveillance system, at least some of the sensors of the one or more sensors configured to capture visual identifiers for each of the plurality of targets comprise an automated license plate reader positioned at one or more of the selected locations.

In embodiments of the surveillance system, the intelligence system is further configured to track one or more targets of interest using updated real-time captures of the visual identifiers of the one or more targets of interest or the one or more electronic signatures associated targets at selected locations by additional ones of the one or more collection systems.

In embodiments of the surveillance system, each of the one or more collection systems comprise a sensor assembly, including an array of sensors each configured to detect and capture one or more electronic signals associated with the plurality of targets. In embodiments, the array of sensors includes one or more of a Bluetooth® antenna, a Wi-fi antenna, a RFID antenna, or other RF antenna.

In embodiments of the surveillance system, at least some of the sensors of the one or more sensors configured to capture visual identifiers for each of the plurality of targets comprise one or more cameras configured to capture at least one of a plurality of vehicle identifiers of the plurality of targets. In some embodiments, the visual identifiers include one or more of license plates, stickers, patterns, position(s) of component parts, after-market added parts, damage, or combinations thereof, of a vehicle.

In embodiments of the surveillance system, the non-unique characteristics comprise a frequency of occurrence, relative representation, signal type, signal receipt location diversity, and signal strength profiling, and wherein filtering the captured electronic signals associated with each target in view of the one or more non-unique characteristics of the captured electronic signals further comprises determining whether a relative certainty value that the captured electronic signals is associated with the target exceed a prescribed threshold in view of the non-unique characteristics.

In embodiments of the surveillance system, the intelligence system further comprises a user interface configured to display one or more of visual identifiers and electronic signatures associated with each of the identified targets of interest, relationships between the identified targets of interest and one or more electronic devices associated with the electronic signatures, or routes or predicted routes of the targets of interest.

In embodiments of the surveillance system, one or more of the collection systems are configured to analyze a signal value of each captured electronic signal, a strength of each captured electronic signal, a spectrum of each captured electronic signal, embedded identification data of each captured electronic signal, or combinations thereof; determine whether each of the captured electronic signals are from likely-unrelated sources; and if one or more of the captured electronic signals are determined to be from likely-unrelated sources, filter out the one or more captured electronic signals.

In embodiments of the surveillance system, the intelligence system is configured to prioritize one or more of the captured electronic signals for identification of a selected target.

According to other aspects, a method comprises: capturing, in real-time via a plurality of collection systems, at least one visual identifier and associating the at least one visual identifier with a target; capturing a plurality of electronic signals identified with a plurality of electronic devices and associating one or more of the electronic devices with the target; filtering the captured electronic signals of the one or more electronic devices associated with each target in view of one or more non-unique characteristics of the captured electronic signals and developing at least one electronic signature for at least one electronic device associated with each target; correlating the captured at least one visual identifier associated with the target with the at least one electronic signature associated with each target; identifying one or more unknown targets based on the at least one visual identifier associated with each of the one or more unknown targets, the at least one electronic signature associated with each of the one or more unknown targets, or a combination thereof, and one or more prior known factors associated with the target; and tracking one or more targets of interest based on real-time updated captures associated with the one or more targets of interest.

In embodiments of the method, the real-time captures associated with the one or more targets of interest include updated captures of the visual identifiers and electronic signatures from electronic devices associated with the one or more targets of interest at successive times and locations.

In embodiments, the method further comprises comparing the captured visual identifiers associated with the target of interest with identifying information for known targets of interest; and wherein tracking the one or more targets of interest comprises collecting one or more of the visual identifiers, electronic signatures, or a combination thereof, associated with the target of interest at a series of collection stations positioned at selected locations throughout a geographic area, and plotting movement of the target of interest throughout the geographic area. In some embodiments, the identifying information for known targets of interest includes vehicle identifiers comprising one or more of a license plate number, stickers, patterns, position(s) of component parts, after-market added parts, damage, other markings, or combinations thereof.

In embodiments of the method, the non-unique characteristics comprise a frequency of occurrence, relative representation, signal type, signal receipt location diversity, and signal strength profiling, and wherein filtering the captured electronic signals associated with each target in view of the one or more non-unique characteristics of the captured electronic signals further comprises determining whether a relative certainty value exceeds a prescribed threshold, wherein the relative certainty value is based on determination of one or more captured electronic signals being associated with the identified target of interest in view of the non-unique characteristics.

In embodiments, the method further comprises displaying, via the user interface in communication with an intelligence system, the associations between the one or more of the plurality of targets and the one or more of the plurality of electronic devices.

In embodiments of the method, filtering the captured electronic signals in view of one or more non-unique characteristics of the captured electronic signals comprises analyzing a signal value of each captured electronic signal, strength of each captured electronic signal, a spectrum of each captured electronic signal, embedded identification data of each captured electronic signal, or combinations thereof, and determining whether each of the captured electronic signals are from likely-unrelated sources.

In embodiments of the method, filtering the captured electronic signals in view of one or more non-unique characteristics of the captured electronic signals is conducted at one or more of the collection systems.

In embodiments of the method, tracking the one or more targets of interest comprises determining a location of a selected target, an association of the selected target to one or more persons, association of the target to one or more locations, travel patterns of the selected target, or combinations thereof.

Accordingly, embodiments of a surveillance system and methods, including systems and methods for facilitating collection and correlation of electronic signatures and/or visual identifiers for targets or convoys that are directed to the above discussed and other needs are disclosed. The foregoing and other advantages and aspects of the embodiments of the present disclosure will become apparent and more readily appreciated from the following detailed description, taken in conjunction with the accompanying drawings. Moreover, it is to be understood that both the foregoing summary of the disclosure and the following detailed description are exemplary and intended to provide further explanation without limiting the scope of the present disclosure.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIGS. 1A-1E are schematic diagrams of a surveillance system according to the present disclosure.

FIGS. 2A-2D are schematic diagrams of an example collection point system of the surveillance system.

FIGS. 3A-3G show examples of screen shots of an interface of a surveillance system according to FIGS. 1A-1E, including an example, theoretical mapping of potential locations for collection systems.

FIGS. 4A-4C illustrate example use analysis operations according to embodiments of the present disclosure.

The use of the same reference symbols in different drawings indicates similar or identical items.

### DETAILED DESCRIPTION

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

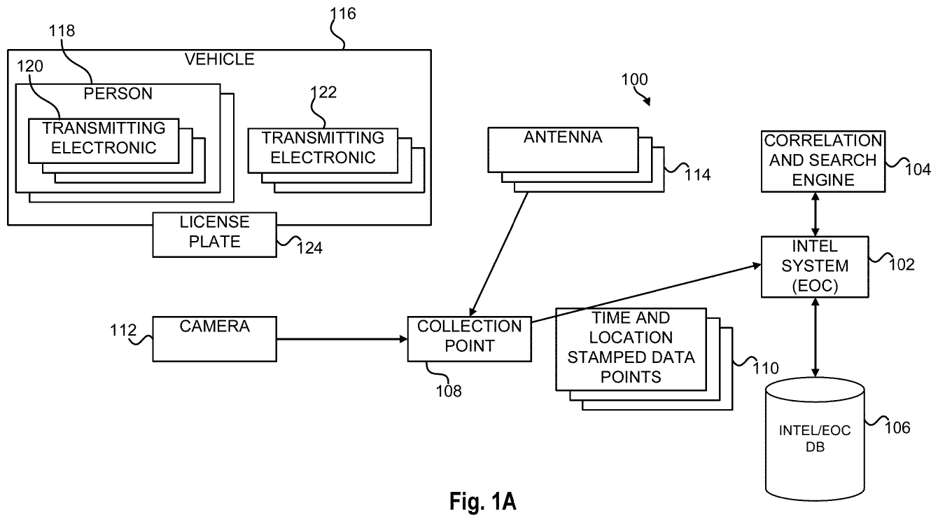

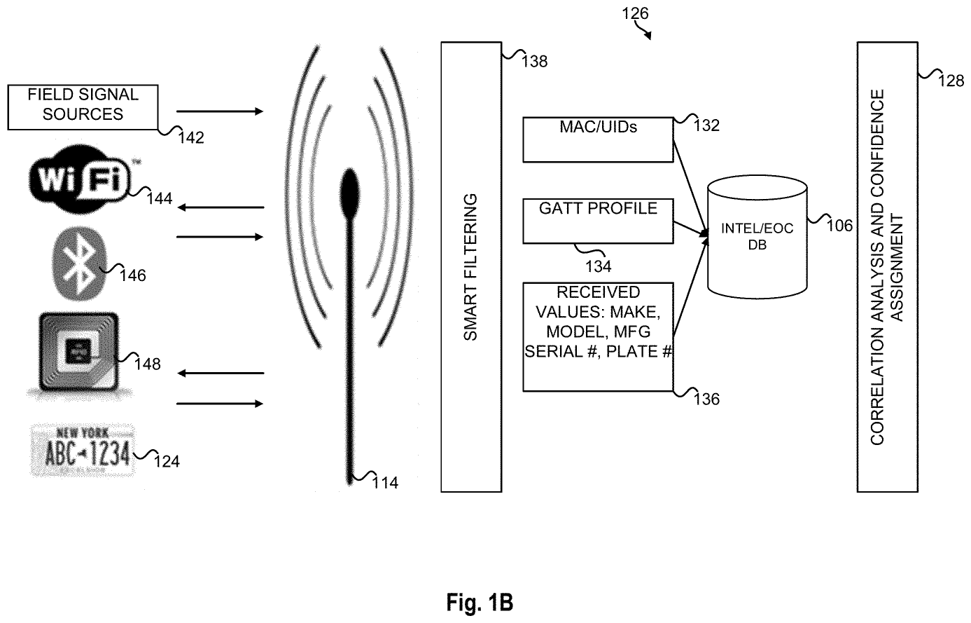

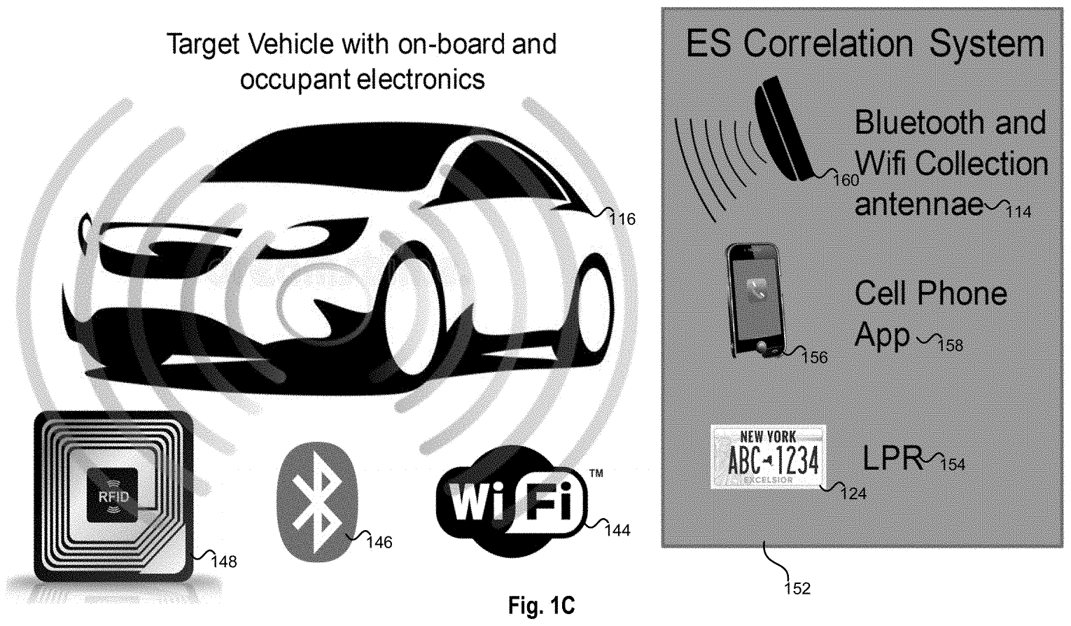

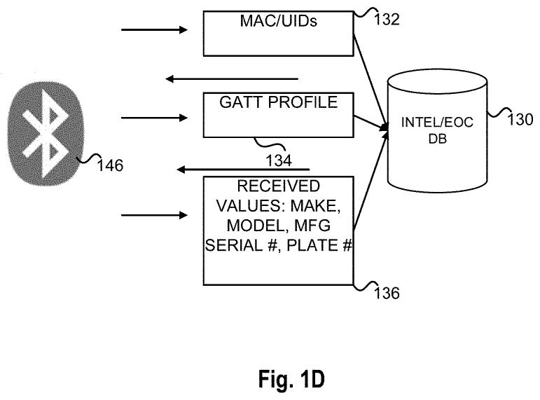

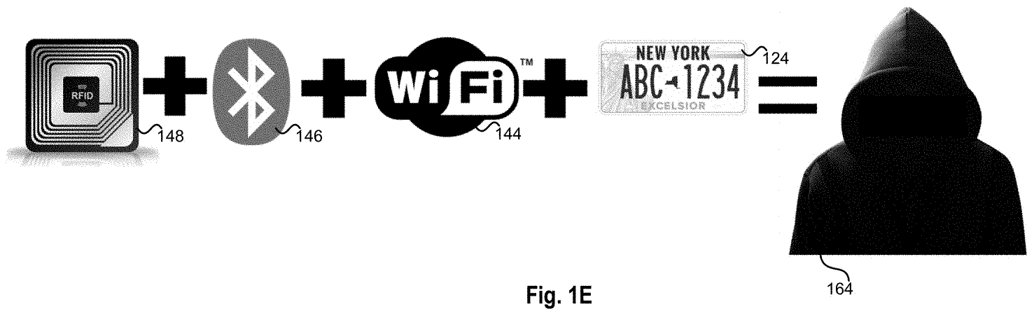

FIGS. 1A through 1E provide schematic diagrams of example embodiments of a surveillance system 100 for collecting and correlating electronic signatures and/or visual identifier information to build intelligence databases that facilitate tracking and associating indications of common location and movement of targets throughout selected geographic areas or locations at specified times.

In embodiments, the surveillance system 100 is configured to enable advanced correlation searching, including correlation analysis that can incorporate/utilize a series of methods, models and processes for the correlation of identifying-characteristics and/or identifiers including license plate, electronic signals and visual idiosyncrasies, such that an operator can use known factors to identify previously unknown factors or can use patterns of activity, identifying information, electronic signals or visual idiosyncrasies to draw conclusions about the vehicles location, association to persons, association to locations and/or travel patterns. The surveillance system 100 thus enables an operator to use known factors to identify previously unknown factors or use patterns of activity, identifying information, electronic signals, or visual idiosyncrasies to draw conclusions about the vehicle's location, association to persons, association to locations and/or travel patterns.

In addition, in embodiments, the surveillance system can enable filtering the captured electronic signals in view of one or more non-unique characteristics of the captured electronic signals, such as by analyzing a signal value of each captured electronic signal, strength of each captured electronic signal, a spectrum of each captured electronic signal, embedded identification data of each captured electronic signal, or combinations thereof, and determining whether each of the captured electronic signals are from likely-unrelated sources. In some embodiments, such filtering the captured electronic signals in view of one or more non-unique characteristics of the captured electronic signals can conducted at one or more of the collection systems of the surveillance system, or at an intelligence system of the surveillance system, such as by a classification and search engine thereof.

The surveillance system and methods implemented thereby further can enable tracking one or more selected targets or targets of interest. In operation, the surveillance system can enable an operator to determine a location of a selected target, an association of the selected target to one or more persons, association of the target to one or more locations, travel patterns of the selected target, or combinations thereof, and can use such information to develop analyses, conclusions and/or prioritizations of identified targets in response to reported events within the geographic area within which the collection systems are positioned or located.

In embodiments, the surveillance system can use characteristics of the collected identifying characteristics to prioritize or otherwise indicate to an investigator that a particular characteristic is material to the identification of the target of an investigation. For example, if a crime or other incident is reported to have occurred within an area, identifications of various targets can be compared to known target identifications; and/or collected electronics signature information can be used to enable prioritization of selected targets or particular targets of interest by an investigator. A target such as a suspect vehicle that is identified as a known offender e.g., using an ALPR read and/or other visual identifiers associated with the vehicle, and/or an electronic signature associated therewith that is detected within the geographic area in which the crime is reported can be prioritized for investigation; or alternatively, the correlated identifiers can be used together to prioritize certain identified targets. In the event of multiple, similar crimes in the geographic area (e.g., a string of robberies over time in an area), the correlated visual identifiers and electronic signatures associated with one or more targets can be analyzed to prioritize and/or flag targets of interest based on factors such as frequency of appearance, location, path of travel, etc.

The surveillance system further can filter and/or reduce noise from electronic signals unrelated to the selected targets. In embodiments, the surveillance system can compare the received visual identifiers and electronic signature information and can compare this to known information to remove or ignore vehicles, persons or other targets.

In embodiments, the surveillance system 100 can filter and sort results (e.g., via a smart filtering engine or device 138) such that the user is directed to signals most likely to have originated from the same set of devices travelling together. “Signals” here can mean electronic signals, visual identifiers, or license plate identification. In addition, the use of the transmitted methods and features of an electronic source with respect to signal strength, advertised methods, order of advertised elements, public and private attributes, and/or signal spectrum utilization by the surveillance system, as described further herein, can be used to collectively identify that source relatively distinctly.

In embodiments of the methods disclosed herein, the method(s) can incorporate correlation confidence assignment (e.g., via correlation analysis and confidence assignment 128) whereby correlated results between electronic signature and targets are analyzed using factors such as a frequency of occurrence, relative representation, signal type, signal receipt location diversity and signal strength profiling to generate and present confidence levels for correlations between signal-receipt events. The methods further will use correlation statistics and analysis to develop relationships between identifiers and non-unique characteristics, such as frequency of identifications, and other factors, captures/associated over multiple encounters. No single factor is required to be an absolute or unique identifier. In some embodiments, for example, captured signals or factors can be related to locations that could also be correlated or associated with other factors such a set of captured license plates, witness statements, etc. The cross-correlations also can be broken into subsets for filtering and generating confidence in the results of such advance correlation searching. The combination of non-unique characteristics and broadcast or visible variables, methods and transmitted values are used to identify a set that are collectively statistically significant in their unique association with the source entity.

In other embodiments, the method can include correlation data noise-reduction at a collection point for filtering in-coming electronic signals to maximize the receipt and storage of moving, stable, identifiable signals by analyzing the signal value, strength, spectrum, and embedded identification data. The method also can substantially simultaneously reduce and filter signals and identifiers that are ‘noise’ from likely-unrelated sources and not relevant to the future correlation.

As indicated in FIG. 1A, the surveillance system 100 includes a plurality of collection systems or assemblies 105 that are located at selected geographic areas or locations (e.g., at one or more collection points 108). The collection systems 105 generally will be configured to capture or facilitate collection of information related to visual identifiers and/or electronic signatures associated with targets. The targets generally will include persons 118, vehicles 116, or a combination of both in and/or moving about the selected areas or locations. Targets also can include transmitted electronic devices 120, 122 or other objections, without departing from the scope of the present disclosure. The collection systems 105 can be positioned at various locations or collection points 108 about a specific geographic area, e.g., a municipality, county, other public or private areas, or combinations thereof.

FIGS. 1A-1B further show an embodiment wherein each collection system includes a sensor or sensor assembly configured to collect or otherwise capture the information related to visual identifiers and/or electronic signatures of targets. The sensor or sensor assembly accordingly can include one or more cameras 112 or camera systems configured to capture or facilitate collection of information related to vehicle identifiers, such as visual or imaged information (e.g., video or photographic or digital images) related to a license plate 124 of a vehicle 116 and/or other visual vehicle identifiers that can be used to discern, detect and/or otherwise identify or confirm the identity of a target vehicle 116.

For example, in some aspects, such as shown in FIGS. 1B-1C, such vehicle markings can include, but are not limited to, signage, stickers, bumper stickers, non-license plate tags, patterns, position or configuration of component parts, damage to the vehicle, such as scratches, dents, repair marks, etc. and the location thereof on the vehicle, small markings or symbols or other indicia on vehicle components, as well as various other identifiable visual markings, or combinations thereof. In some embodiments, the camera system also can include an Automated License Plate Reader (“ALPR”) integrated or otherwise associated with a collection system 105, or the surveillance system 100 can include ALRPs in addition to, or in place of, one or more collection systems.

In addition, or in the alternative, the at least one sensor or sensor assembly also can include an antenna 114, antenna array, or plurality of antennas configured to capture or otherwise receive electronic signals from transmitting electronic devices 120, 122 associated with the targets for identification/extraction of electronic signatures. The at least one sensor or sensor assembly can include additional sensors, such as IR sensors or other light sensors, without departing from the present disclosure. Other information or data may be obtained from other sources (e.g., a cellular phone 156) via other sensors and/or other algorithms or instructions (e.g., cellular phone applications 158).

The transmitting electronic devices 120, 122 can include, but are not limited to, transmitting electronic devices associated with a vehicle 116, such as vehicle components including, but not limited to, tire pressure sensors or other manufacturer installed or after-market vehicle sensors, vehicle stereo or entertainments systems, vehicle navigation systems, vehicle infotainment systems, self-driving or driver assist vehicle guidance systems, vehicle Wi-Fi hotspots, other components of internal or external vehicle systems, etc. . . . ; and additionally can include transmitting electronic devices associated with persons 118 or other types of targets, including, but not limited to, cellular phones 156 and/or other communication devices, tablets, laptops, smart watches, fitness trackers, wireless headphones, RFID tags 148 (e.g., key cards, library books, assets tags, pallet transmitters, pet collars), Wi-Fi hot spots, and other personal electronic devices 160. Each sensor or sensor assembly is configured to capture or collect signals transmitted by or otherwise emanating from the transmitting electronic devices when the targets get within proximity of the collection systems.

The collection systems also can be configured to receive signals at a prescribed or selected proximity in relation thereto. For example, in some embodiments, the collection systems could be configured to look for and receive signals transmitted within about 200 feet of the collection systems; while in other embodiments, such as to reduce or limit extraneous noise or to help filter such noise, shorter ranges of signals also can be used, i.e. in some locations, the collections systems can be configured to receive signals transmitted within about 100 feet of the collection systems, and in still other embodiments or locations, signals transmitted within about 50 feet of the collection systems. Other, varying ranges also can be used.

In addition, as indicated in FIG. 1A, the surveillance system 100 includes an intelligence system 102 that is in communication with the plurality of collection systems. The intelligence system 102 is configured to receive information collected or captured by the collection systems and to identify and/or track targets or correlate a target with other targets or electronic devices based on this received information (e.g., time and location stamped data points or information 110). The intelligence system can be in wireless communication with the collection systems, e.g., through a public or private network using Wi-Fi, cellular, etc. . . . In addition, or in the alternative, the intelligence system and one or more of the collection systems can be connected through one or more wired connections. In this regard, when targets come within proximity of the collection systems, the collection systems will collect visual information and/or electronic signal information associated with the targets and transmit data points or packets of information, e.g., time and location stamped information 110, related to collected visual and/or electronic signal information to the intelligence system.

The collection systems can be configured to transmit data points or packets substantially simultaneously or generally in real time when targets come within proximity to the collection systems. For example, the collection systems can send a data point including information corresponding to each electronic signal or visual identifier as it is captured or can send a data packet including information corresponding to multiple electronic signals or visual identifiers received. In addition, or in the alternative, the collection systems can transmit the data points or packets at specific time intervals, such as every few seconds, minutes, hours, etc. or at other times or intervals after the electronic signals or visual identifiers are captured, without departing from the scope of the present disclosure.

FIG. 1A further shows that the intelligence system 102 will include a correlation and search capabilities or one or more correlation and search engines (e.g., the correlation and search engine 104 or the ES correlation system 152 of FIG. 1C) and an intelligence database 106. The correlation and search engine is configured to identify or extract electronic signatures and/or other targets associated with a target using collected visual and/or electronic signal information at the collection systems. In particular, the correlation and search engine 104 is configured to ingest or process the data points/data packets to associate or correlate the visual identifiers with the received electronic device signals and/or other visual identifiers of other targets to facilitate the identification or extraction of electronic signatures and/or other targets identifying the targets. In such embodiments, such an association or correlation can be utilized by the correlation and search engine to create a convoy or, in other words, a group of targets which may travel together at varying times on varying dates.

In embodiments, the electronic signatures can include information related to the collected electronic signals of the transmitting electronic devices 120, 122 or combinations of collected electronic signals of the transmitting electronic devices that uniquely identify the targets. For example, and without limitation, a combination of one or more signals from a plurality of transmitting electronic devices (e.g., a watch, cell phone/communication device, headphones, etc.) can include an electronic signature that uniquely identifies a person 118 (e.g. the electronic signature may be received as or may include a MAC user ID 132 and/or a GATT profile 134); a combination of one or more signals from a plurality of transmitting vehicle components (e.g., a vehicle sensor, infotainment system, etc.) can include an electronic signature that uniquely identifies a vehicle, or one or more signals from a transmitting electronic device can include an electronic signature that uniquely identifies that electronic device.

The correlation and search engine 104 further can be configured to filter or otherwise alter the received electronic signatures (or information related thereto) to reduce or diminish signal noise and facilitate identification or extraction of unique, identifying electronic signatures. For example, the correlation and search engine can apply filtering (e.g., linear or non-linear filters, dynamic noise reduction, etc.) to collected electronic signals to diminish, reduce, or substantially eliminate stationary and variable noise and other values that cannot be usefully correlated with targets, allowing unique electronic signal values to be extracted or identified.

In addition, the correlation and search engine 104 is configured to catalogue the electronic signatures and/or visual identifiers in the intelligence database with specific identifying characteristics allowing these identified electronic signatures and/or visual identifiers to become unique, identifiable, and searchable. The identifying characteristics can include, but are not limited to, geographical coordinates, time stamps, source manufacturer, source type and unique ID, etc. . . . The correlation and search engine also can be configured to build catalogs or groupings of independent data points/data packets in the intelligence database that allow correlation analysis to show what otherwise anonymous or non-unique electronic signals and/or other visual identifiers (e.g., other license plates) consistently appear with the targets.

The surveillance system 100 thus can identify, track, map, catalogue, etc., the presence and/or movements of the targets in real time as electronic signals emanating therefrom occur in proximity to the collection systems or based on image captures of visual identifiers. The surveillance system further can generate alerts or notifications when certain targets are in proximity to the collection systems. Still further, the surveillance system further allows for the searches or queries of the intelligence database, e.g., for investigating locations or movements of suspects or other persons of interest.

In embodiments, the correlation and search engine can include and use or be configured to utilize or use algorithms, models, statistical models, machine learning algorithms/models, Big Data analysis or statistics, etc., to infer relationships between transmitting electronic devices and/or targets based on consistency or likelihood of correlation of the visual identifiers and/or electronic signals of the transmitting electronic devices. For example, the correlation and search engine 104 can be configured to evaluate and combine singular collection events at the collection systems with other catalogued events in the intelligence database 106 to develop correlated information related to the intersection of multiple collected/captured electronic signals and/or visual identifiers that occurred at a specific time and geographical area or location. And, the correlation and search engine can use the frequency and/or consistency of electronic signals and/or visual identifiers received at collection systems to determine the relative certainty of association of the transmitting electronic devices 120, 122 and/or targets to develop electronic signatures (correlated electronic devices) or correlated targets (e.g., correlated license plates) for the targets.

The correlation and search engine 104 can be programmed to determine a likelihood or probability that a specific electronic signal, a combination or set of electronic signals, and/or other target or targets are associated with a target, and if the determined likelihood or probability meets a prescribed/selected likelihood or probability threshold, the engine will identify or extract an electronic signal or combinations of electronic signals as an electronic signature or electronic signatures to be associated with that target. In one embodiment, the likelihood or probability threshold can be about 70% or more (e.g., above 75%, above 80%, above 85%, above 90%, above 95%, above 98%, etc.) that an electronic signal, combination/set of electronic signals, and/or other targets are associated with a particular target.

For example, the correlation and search engine 104 may correlate two or more license plates and one or more electronic devices based on multiple events that such a combination is received. Based on such a correlation, a prediction of when a particular vehicle 116 may be present at a specific location may be determined by the correlation and search engine. Further, the two or more license plates may be from or may define a convoy (e.g., group of targets or target vehicles). In such an example, the electronic devices may be associated with the convoy.

In some embodiments, the correlation and search engine can be configured to determine or identify a location at which a visual identifier and correlated electronic signature and/or other visual identifier are matched to enable tracking and/or verification of targets at such a location. In addition, or in the alternative, the correlation and search engine can be configured to associate identifying electronic signatures and/or other visual identifiers with visual identifiers, such as a visual vehicle identifier, to allow independent tracking and location identification of targets based on the associated identifying electronic signatures and other visual identifiers. For example, once the engine has records correlating electronic signatures and/or other visual identifiers, e.g., a license plate likely to be located at or near a specific visual vehicle identifier, associated with the specific visual vehicle identifier, e.g., a specific license plate number, the correlation and search engine will be able to detect the likely presence of a vehicle and its associated license plate without visual information of that specific vehicle, e.g., a camera may or may not be used. Furthermore, the collection systems can be placed in locations or areas not associated with vehicular traffic, such that the intelligence system will be able to identify, and catalogue known electronic signatures away from the vehicles they have typically been associated with.

In this regard, in embodiments, such as those illustrated in FIGS. 1B-1E, the collection systems can be used in conjunction with existing ALPRs 154 in certain areas or locations, allowing the intelligence system to capture and develop a subset of electronic signatures and/or other license plate reads associated with a license plate 124 of a vehicle 116 that is read at a moment in time and location. For example, one or more collection systems 105 can be positioned near or in close proximity to an existing ALPR, which is configured to capture license plate information 124 or other information comprising, known factors that are identifiable with a known target (e.g., a target such as indicated at 164 in FIG. 1E). As indicated in FIGS. 1B and 1C, in conjunction with the information (e.g., plate reads, make & model information, etc., such as indicated at 136) by the ALPR(s), the additional collection systems will collect additional factor information such as field signal sources 142, Wi-Fi 144 or Bluetooth signal signatures 146, RFID 148 and other transmitted signals, etc., which can be correlated or associated with received electronic signals with license plate reads, such as generally shown in FIGS. 1D-1E.

In addition, or in the alternative, an existing ALPR 154 can be modified or retrofitted to include components of the collection point systems to enable collection of electronic signals jointly with license plate reads. Further, in some embodiments, collection systems with or near cameras 112 or ALPRs 154 can be used in connection with collection systems without cameras or ALPRs, as generally indicated in FIG. 1A.

As a result, electronic data points from less expensive collection systems can be used to provide more precise tracking than ALPR 154 alone. That is, the lower cost collection systems can increase collection density beyond the collection of ALPR or camera records, enabling data from both collection system types to be combined to provide more detailed intelligence and increased accuracy of verification or authentication of possible targets, including providing monitoring personnel (e.g. law enforcement, security or other personnel) with an increased level of confidence of locations of potential criminals, stolen or other vehicles of interest.

Additionally, or alternatively, collection systems 105 without cameras 112 (or with cameras) can be positioned in areas or locations that cannot be accessed by a vehicle, such as on trains, near railways, around public buildings, etc., to enable collection of electronic signals from persons away from their vehicle, e.g., for cataloguing, tracking, mapping, etc. . . . positions or movements thereof.

The intelligence system generally includes one or more processors, controller's, CPUs, etc., and one or more memories, such as RAM, ROM, etc., in communication with the one or more processors. The correlation and search engine 104 can include computer programming instructions stored in the one or more memories that can be accessed and executed by the one or more processors to facilitate execution of the processes thereof, e.g., correlation of information, identification and tracking of the targets, searching of the intelligence database, etc. . . .

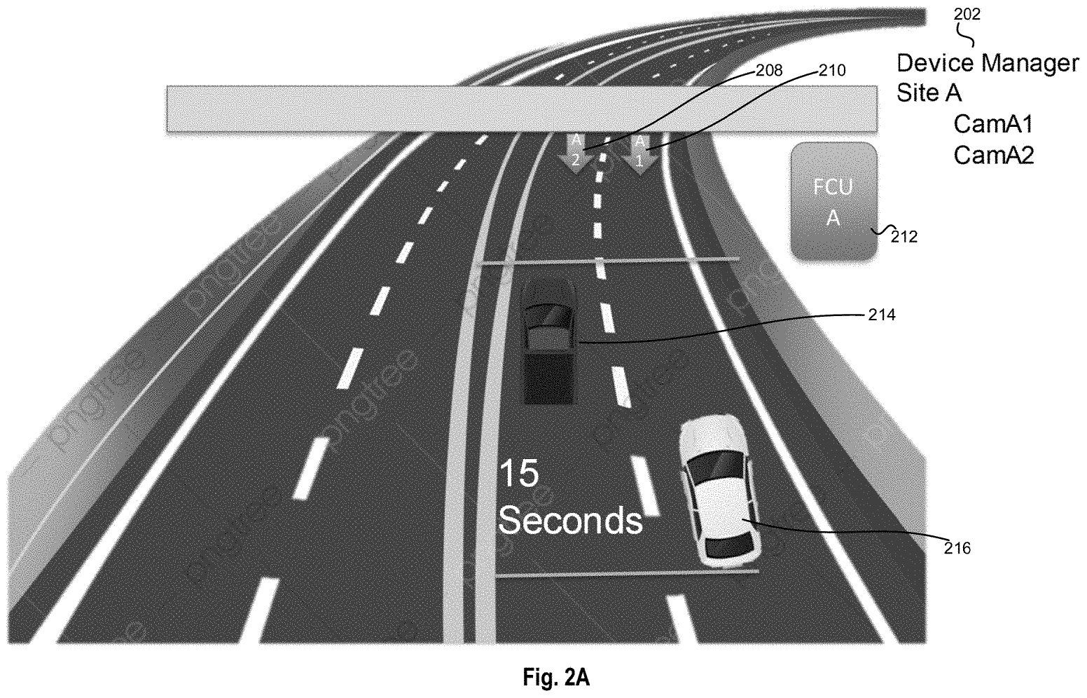

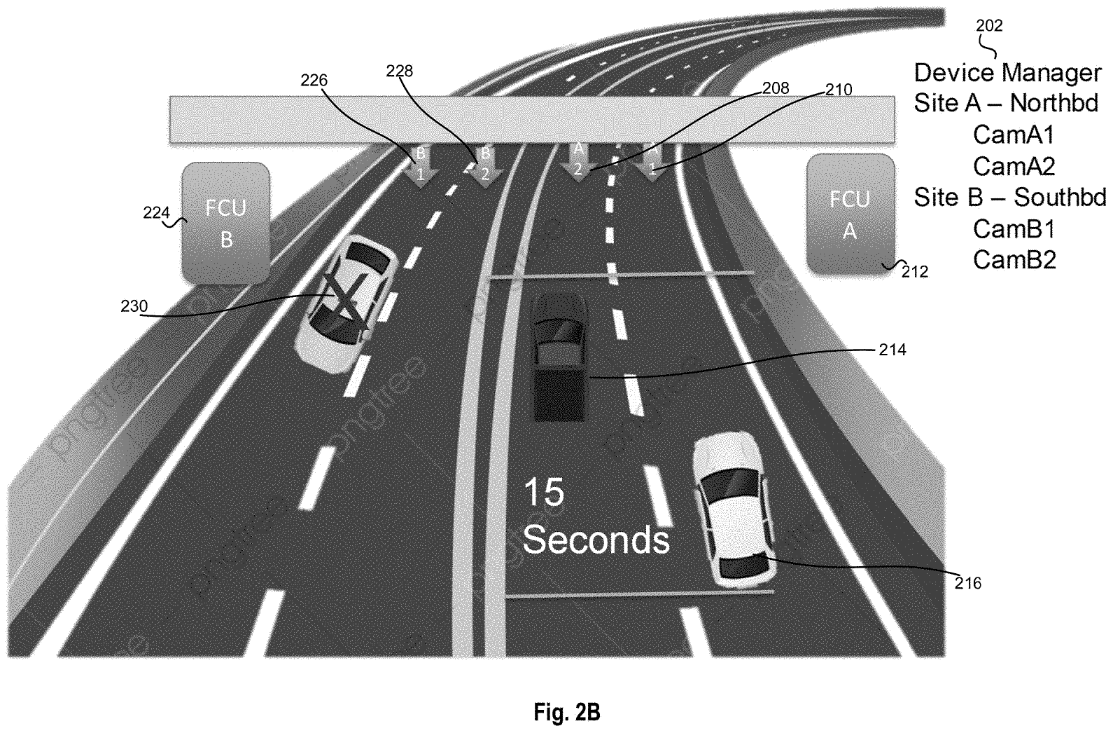

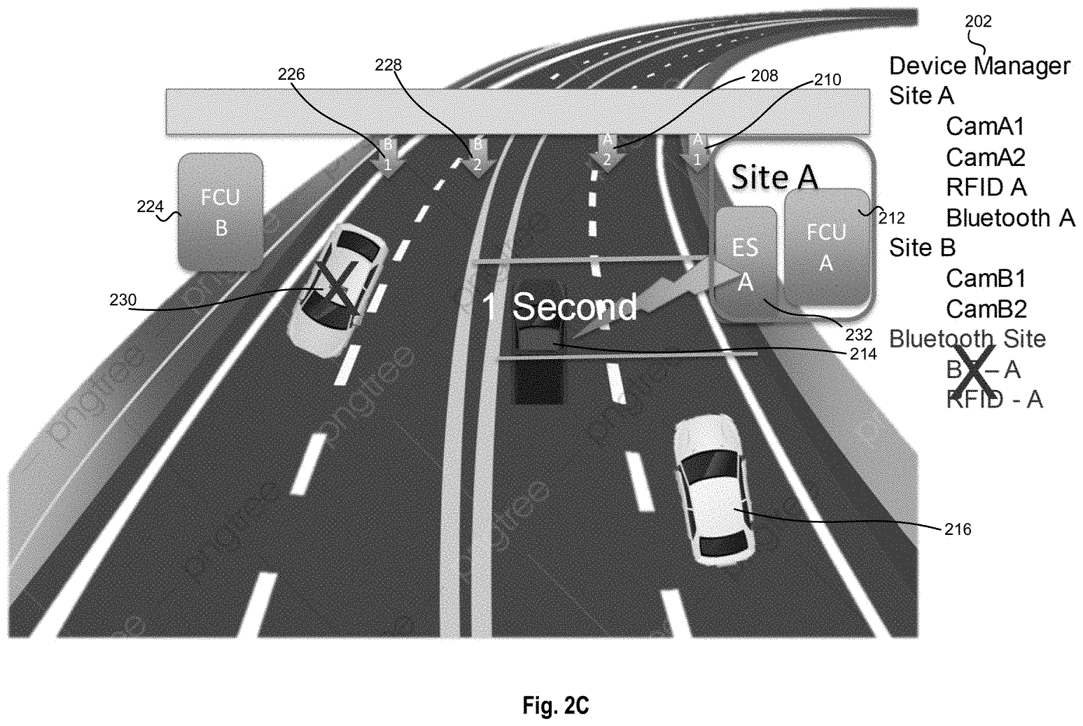

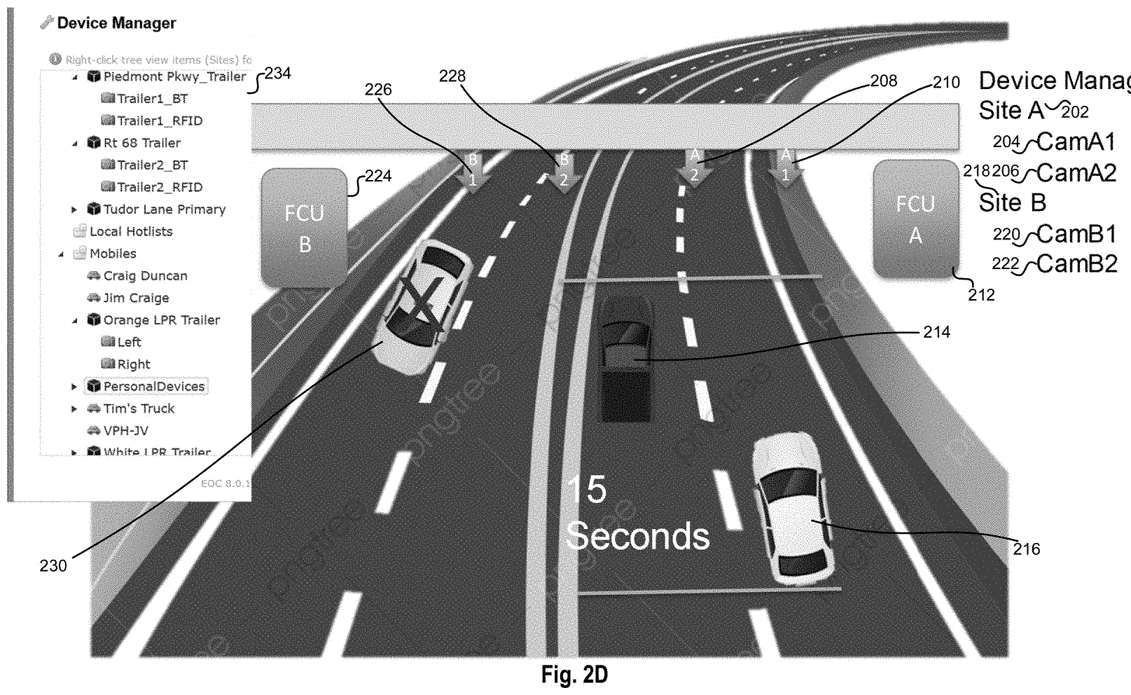

FIGS. 2A-2D illustrates an example of how a collection point system of the surveillance system may operate. In such an embodiment, a collection point system may include a number of cameras and electronic signal detectors 208, 210, 212, 224, 226, 228, 232 (e.g., RFID and/or Bluetooth®). At a point in time when several (e.g., three in FIG. 2B-2D) 214, 216, 230 vehicles pass the collection point system in the same direction, each vehicle's license plate and associated electronic signals may be recorded or scanned and recorded. A time stamp associated with such a recording may be stored alongside the other gathered data. Once the data is received, the correlation and search engine may determine whether a correlation exists between the three vehicles and the electronic signals generated by each.

The correlation and search engine, for example, may determine such a correlation based upon similar events that occur over multiple days. In other words, the correlation and search engine may utilize a number of times two vehicles travel together through a collection system. The correlation and search engine may remove possible correlation between vehicles as well. For example, a vehicle passing in the opposite direction will most likely not be a part of a convoy or group related vehicles. The collection system may include or may be included in or as a part of a device manager 202, an intelligence system, and/or a surveillance system. The device manager 202, the intelligence system, and/or the surveillance system may include a user interface configured to display captured data and correlations to thereby allow a user to track one or more targets. Such a collection system illustrated in FIG. 2A-2D may be implemented in or with any of the systems illustrated in FIG. 1A-1E.

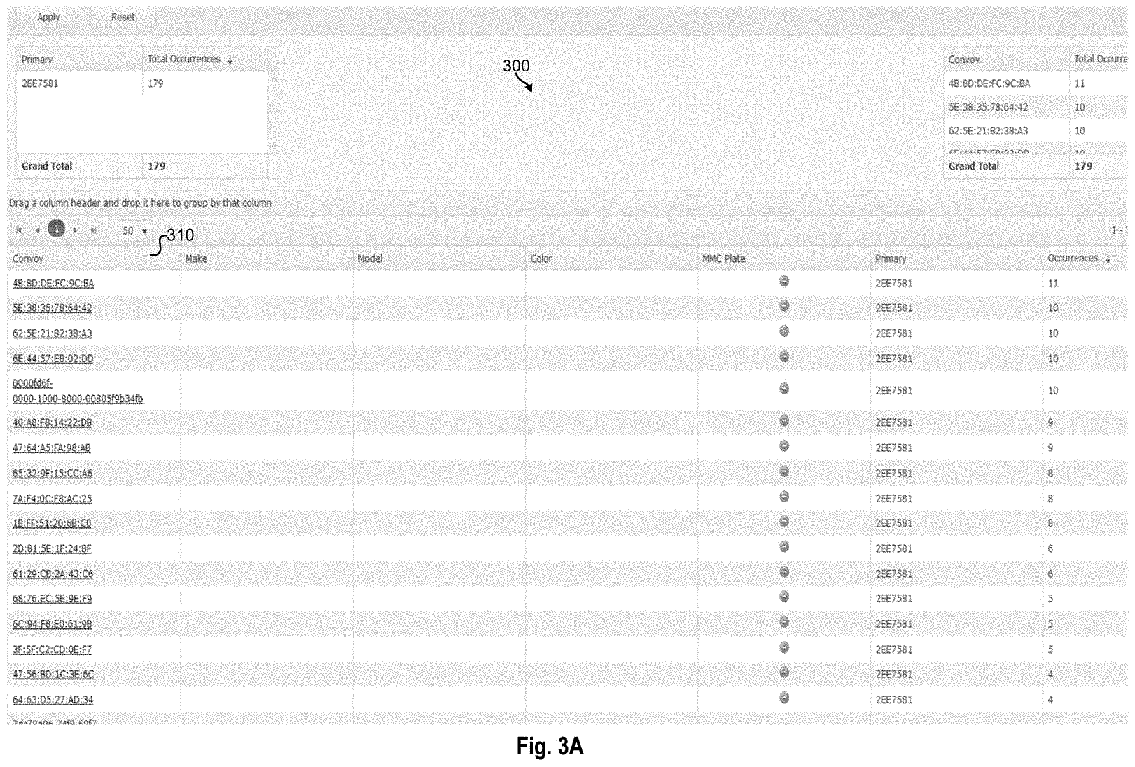

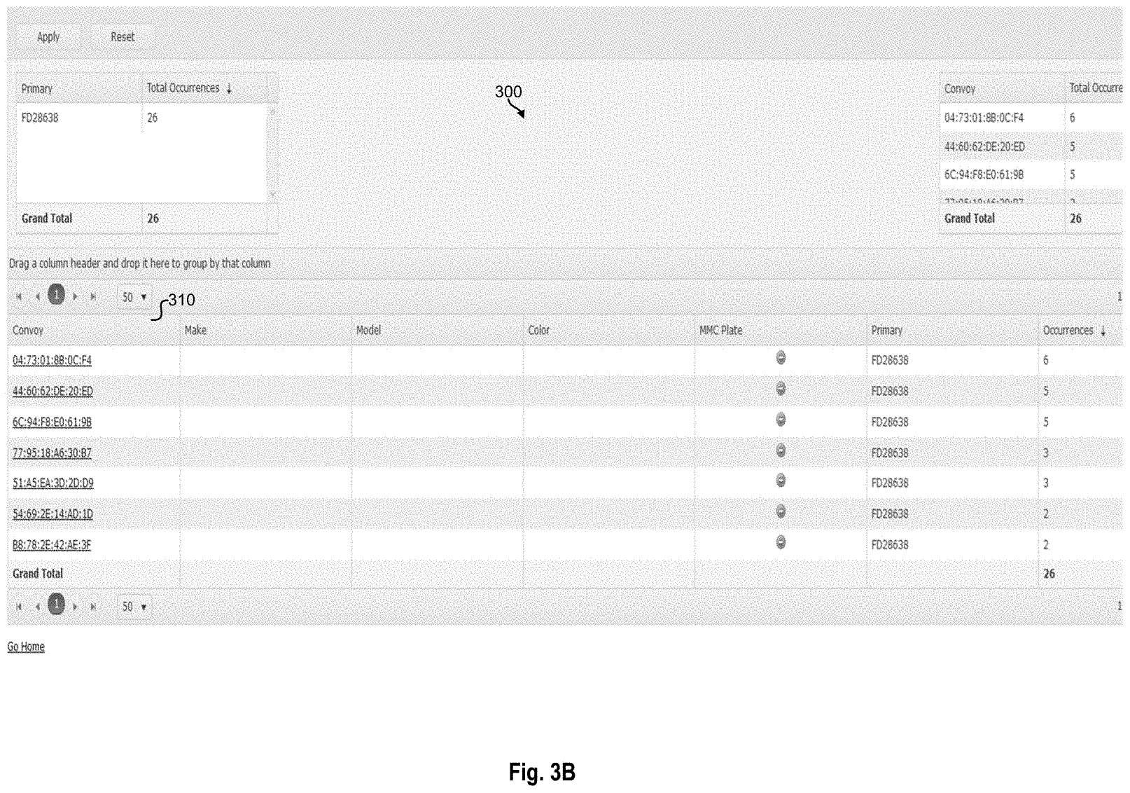

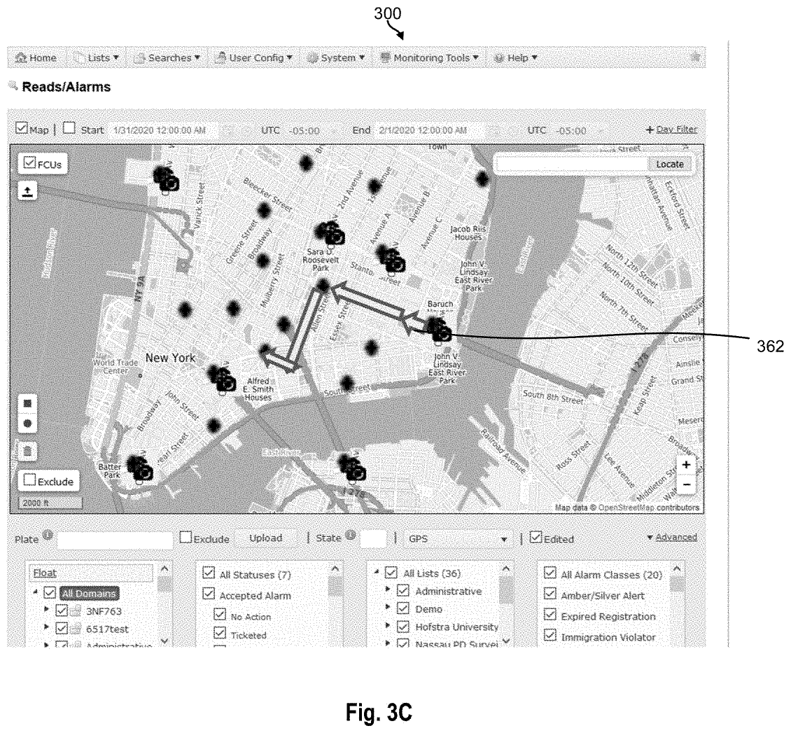

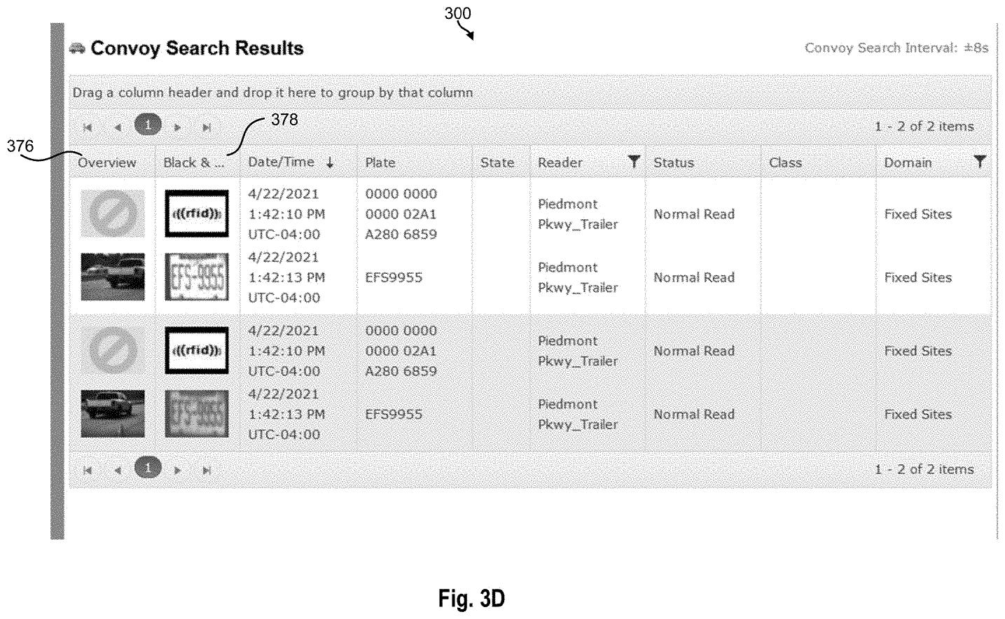

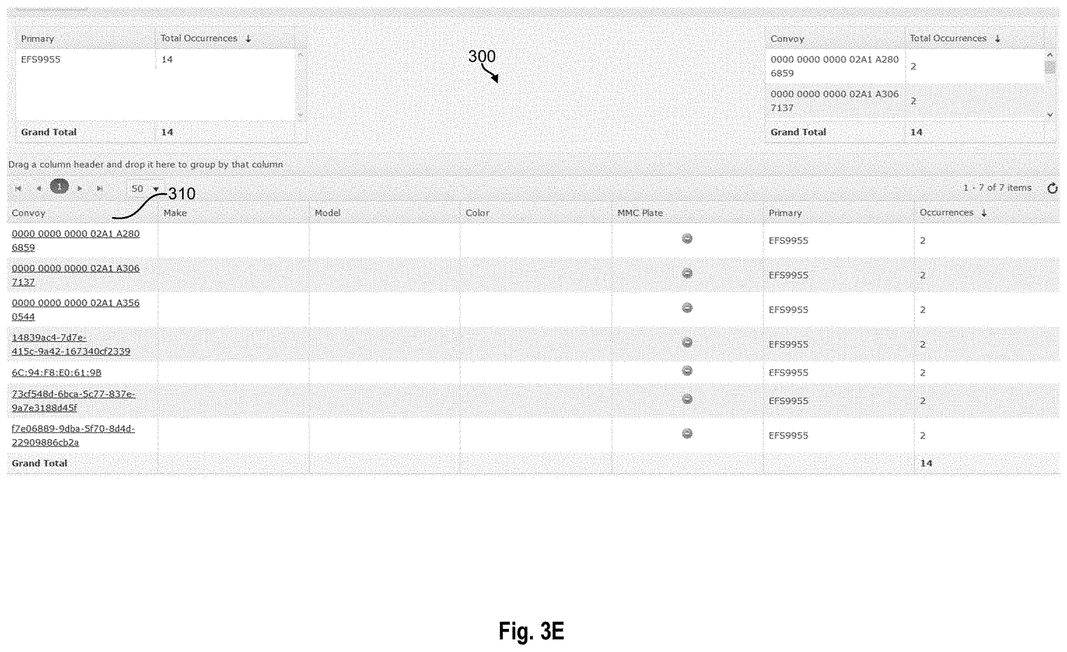

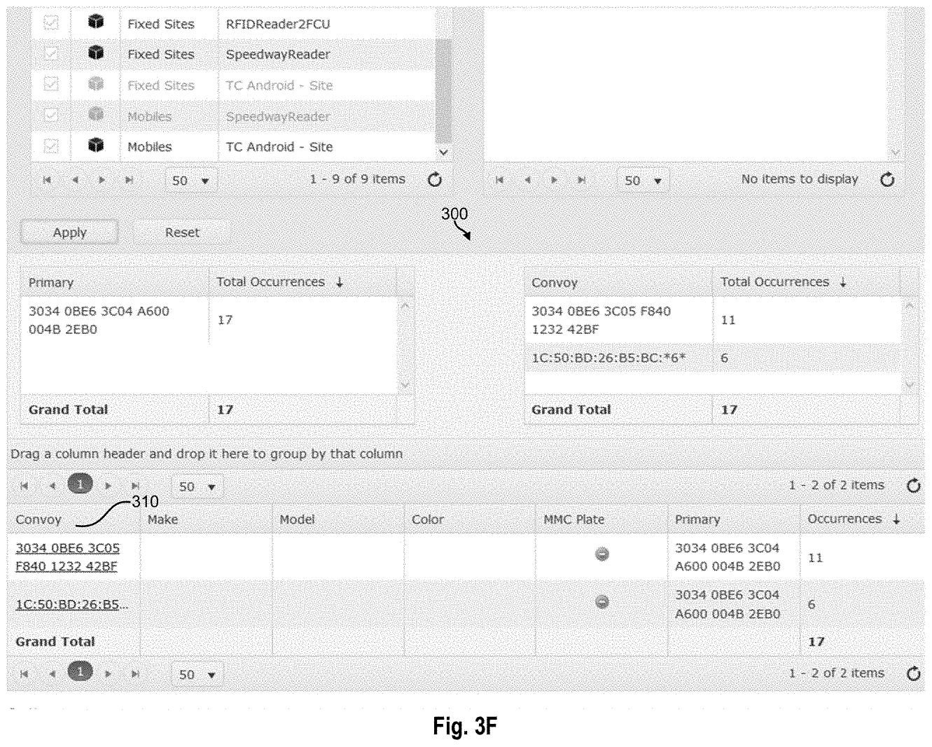

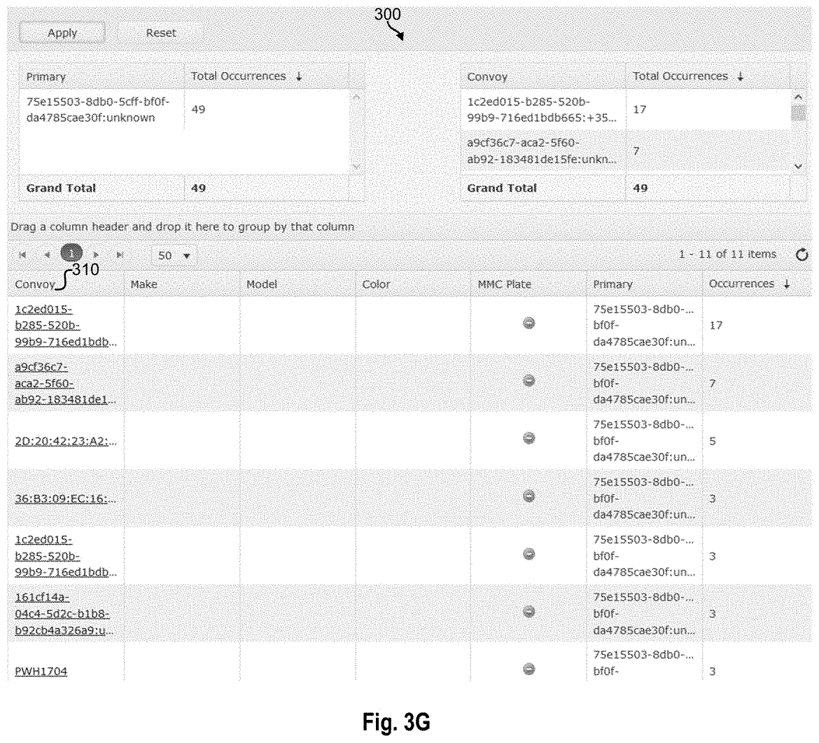

The correlation and search engine can process the information from the received data points or data packages to correlate the received signal information with the visual information to develop electronic signatures uniquely identifying each vehicle based on the received electronic signals or combinations thereof, and also can populate the intelligence database with the signature information identifying each vehicle. As multiple license plates may be read at a time and multiple signals detected, correlation may occur when or if multiple data points exist for a particular vehicle. Operators then can search or query the intelligence database, e.g., using a user interface 300 as shown in FIGS. 3A-3G, for identification, mapping, tracking, etc., of vehicles and/or locations at specific times.

In some embodiments, the surveillance system can be configured to capture an electronic signature and associated information from a target, and can associate such electronic signature, as well as associate other targets, and associated information with the target's identification, e.g., license plate number or other visual identifier, with the correlation and search engine, and then allow searches for or provide alerts or notifications on receipts of similar electronic signature information and/or visual identifier at one or more of the collection systems. In an embodiment, the association or correlation of two or more different license plates, which may include correlated one or more different electronic devices, may form a convoy 310. Convoys 310 may be selectable, as illustrated in FIGS. 3A-3B, and/or locations for searching targets or convoys can be selectable, as indicated in FIG. 3C. The locations illustrated in FIG. 3C are for example only, and merely represent potential, theoretical locations that could be selected and used as described herein.

For example, the surveillance system can be configured to allow for search inquiries or scans of one or more specific electronic signatures associated with a target or convoy 310 or may search for a specific convoy or target associated with one or more convoys, and to provide search results including known location data points and/or known routes at specific times, in the intelligence database, placing the suspect at those locations and times. The search results can include maps 362 or other images showing the collection systems that captured electronic signals associated with the one or more electronic signatures searched, e.g., indicating the selected targets or convoy's presence or movements about a prescribed location or area (FIGS. 3A-3C, 3E, and 3G).

In addition, or in the alternative, the search results can include groupings or listings of search results associating the target, electronic signals, and/or convoy searched with information related to the collection systems which captured target, electronic signals, and/or convoy associated with the two or more targets and/or one or more electronic signatures searched (FIGS. 3D-3G). The grouping or listing can include images 376/378 captured (e.g., images of the person, vehicle, vehicle license plate, etc.), temporal information (e.g., the date and time the visual or signal information was collected), the visual identifier (e.g., license plate number), location information (e.g., GPS coordinates, state, city, etc.), information identifying the collection point system, statues of the collection (e.g., normal read, error, etc.), etc. . . .

In other embodiments, the surveillance system can be configured to allow for labeling or other associating of specific convoys with a selected target or targets and then alert or search for history of those specific electronic signatures in the intelligence database, placing the selected target(s) at more locations than ALPR alone. For example, an investigator can determine a convoy that is associated with a target, e.g., using readings of electronic signals from transmitting electronic devices possessed by suspect taken into custody or other capture of electronic signals from a suspect's transmitting electronic devices. The investigator then can input the electronic signatures (or information related thereto) associated with the target(s) or convoys into the surveillance system to determine which collection systems captured those signatures, e.g., to establish a verifiable record/proof that the suspect or others were at or near a crime scene and/or show other incriminating movements or locations of the suspect, such as a location or movements patterns useful for tracking the commission of a crime. Investigators further can input specific time periods or ranges, and the surveillance system can provide listings of electronic signatures and/or visual identifiers received at various collection systems within the inputted time period/range or can provide maps or other images showing movements of targets or convoys within the inputted time period based on their electronic signatures and/or visual identifiers received at the collection systems. By use of such a system, investigators potentially can be aided in reducing or narrowing a pool of suspects, aiding their investigations.

In addition, the surveillance system can generate an alarm or alert when the specific electronic signature(s) and/or visual identifier correlated to a convoy is captured at one or more of the collection point systems to alert of the presence of the target(s) or convoy at or near the collection point system(s), as illustrated in FIG. 3E. The alarm or alert can be provided to the operator of the surveillance system and/or local authorities, e.g., law enforcement or other third parties. In some embodiments, the target or convoy can be selected based on a specific criteria associated with the target of the convoy, e.g., arrest warrant, Amber or Silver Alert, expired registration, immigration violation, etc. . . . , and when the labeled electronic signatures and/or visual identifiers are collected at one or more of the collection systems, the proper authorities can be notified.

The surveillance system, as noted, can be configured to perform convoy searches or analyses that indicate transmitting electronic devices, i.e., based on their electronic signatures and/or visual identifiers, which typically travel with a vehicle license plate, as generally indicated in FIGS. FIGS. 3A-3B, 3E-3G. For example, as FIGS. 3A-3G, show, the surveillance system may provide listings of electronic signatures that are commonly associated with a target's license plate. An investigator may perform searching on one or more of the associated electronic signatures apart from the target's license plate to pick up locations a target may have traveled when the license plate was not read, e.g., to expand the search of a particular target's movements apart from a vehicle, to pick up location data for a vehicle with a license plate may have been tampered with or otherwise is unreadable/not read. For example, an investigator may have seen that a particular vehicle's license plate has been picked up 20 times and 19 of those 20 times a particular, unique RFID electronic signature also was received, so the surveillance system allows the investigator to look for where else the unique RFID electronic signature was received, e.g., to be able to track a person in places that did not read or pick up their vehicle's license plate to expand the investigation.

In still further embodiments, the surveillance system further can indicate or determine changes in association or travel of suspects based on variations in electronic signatures associated with a target. For example, based on unique electronic signatures, the surveillance system can indicate whether particular individuals are or were traveling with a particular vehicle or vehicles, which can allow investigators to determine whether suspects were actually in a vehicle at a particular time. In addition, the surveillance system can indicate whether the sought after individual or third party by standers are in a vehicle or other structure based on the electronic signatures associated therewith.

By way of example and not limitation, in an embodiment for analysis of electronic signature data, an initial goal is to find associations of electronic signatures and/or targets to known ALPR targets. For this, multiple locations can be used. The repeated linking of a target (e.g., a license plate) to electronic signatures and/or other targets can be the value. For example, a particular license plate can be associated with a convoy, the convoy can be associated with a list of electronic signatures, and the convoy and/or electronic signatures associated with non-LPR sites.

Another goal can include the harvest or collection of values in convoy searches when a target value is unknown. Such a search can be based on a date/time, tight correlations, and/or other factors. Reading a signal simply at one site may not be valuable, but a read at two or more sites may indicate that a target is moving and may be valuable or more valuable than a single read of a potentially stationary target. Using such systems and methods described herein, a search can be quickly refined to values that are read at multiple sites and have convoy hits/correlation or association, with and/or without a plate match. A convoy can be limited by site and by multiple electronic signature reads at a series of sites, e.g., two or more successive sites.

For example, the system can analyze a time proximity map for a site/series of sites around specific convoy or target read pairs, and additional features of one or more electronic signatures that, at least preliminarily, appear to be associated with one or more targets (identified by known identifiers such as ALPR data for their vehicle) can be added and analyzed—e.g. a signal strength of an electronic signature signal, such as an RFID, Bluetooth, cellular or other electronic signal, that makes the likelihood of convoy more clear for electronic surveillance results. To differentiate the collected electronic signature information between such multiple targets, the system will monitor and track/compare signal strengths of the electronic signatures associated with multiple targets over time, together with other factors such as plate reads taken at a series of sites. As a result, while convoy data may initially indicate a greater likelihood of an association of an electronic signature with a particular target plate, based on such other factors such as a signature strength being maintained with a certain target for a longer time, closer differentiations can be made between 2 competing plates/targets, to ensure a correlation between a plate and a recorded electronic signature can be made with high confidence.

As noted, a single read or a single electronic signature value read at only one site may not be valuable. The number of such reads or values can, however, quickly create or generate large amounts of non-valuable data. As such, the systems and methods disclosed herein create a solution for such issues, for example, through the use of convoys (e.g., a single read at one location may be deleted, rather than stored, while a read associated with a particular convoy may be kept or retained). In other examples, different reads can increase value or impact of data, such as convoy pairs at multiple sites, electronic signatures read for a convoy at multiple sites, one-to-one data matches, specific source types (such as RFID), a target alias, and/or few reads over about 1 minute or more for a target. The data generated by such reads may be stored in such a manner that the data is not deleted for specified period of time, and can be accessed, such as via user interface 452.

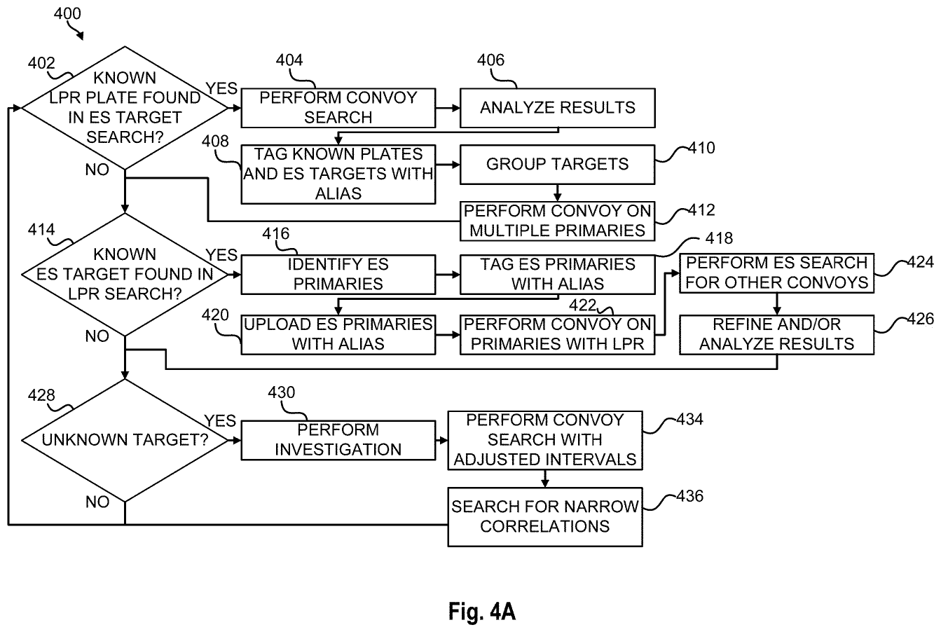

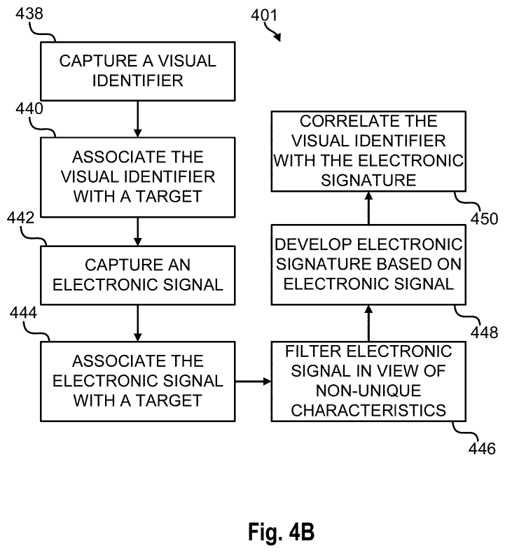

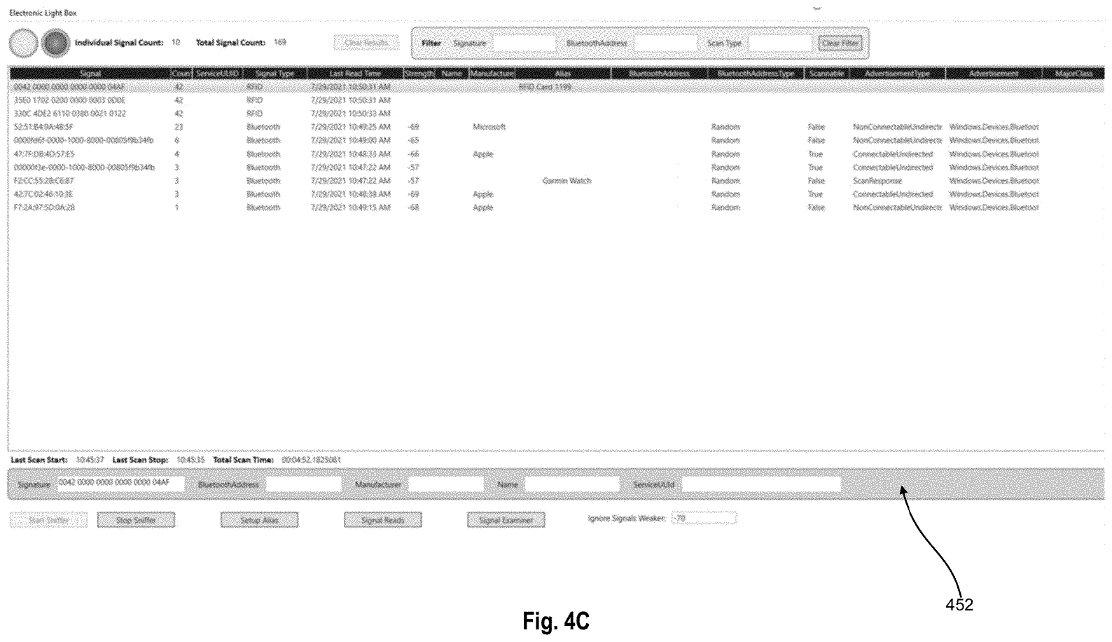

Additional examples of use and analysis operations are illustrated in FIGS. 4A-4C. For example, FIGS. 4A-4B show flow diagrams for capturing and correlating data, according to an embodiment. The order in which the operations are described is not intended to be construed as a limitation, and any number of the described blocks may be combined in any order and/or in parallel to implement the methods.

At block 402, an intelligence system and/or surveillance system may determine whether, during an electronic signature search, a known license plate is read or found. If a known license plate is read, then, at block 404, the intelligence system, the surveillance system, and/or a user may perform or initiate a convoy search. At block 406, the intelligence system, the surveillance system, and/or the user may analyze the results if the convoy search. At block 408, the intelligence system and/or the surveillance system may tag the known license plates and an electronic signature with an alias, a tag, and/or another indicator to indicate that a license plate and an electronic signature are associated with a known target. At block 410, the intelligence system and/or the surveillance system may group the known targets with aliases together. Such a group, in an embodiment, may be considered a convoy. At block 412, the intelligence system, the surveillance system, and/or the user may perform a convoy search using multiple primaries (e.g., license plates and/or other target data).

If, at block 402, a known license plate is not read, then, at block 414, the intelligence system and/or the surveillance system may determine whether a known electronic signature is found in a license plate read search. If a known electronic signature is found, at block 416, then the intelligence system and/or the surveillance system may identify electronic signature primaries. At block 418, the intelligence system and/or the surveillance system may tag the electronic signature primaries with an alias. At block 420, the intelligence system and/or the surveillance system may upload the electronic signature primaries with the alias. Such an upload may be to, for example, an intelligence database. At block 422, the intelligence system, the surveillance system, and/or the user may perform a convoy search on the primaries with a license plate read. At block 424, the intelligence system, the surveillance system, and/or the user may perform an electronic signature search for other convoys. At block 426, the intelligence system, the surveillance system, and/or the user may refine and analyze the results of such a search.

If, at block 414, a known electronic signature is not found in a license plate read search, then, at block 428, the intelligence system and/or the surveillance system may determine whether a target is unknown. If the target is unknown, at block 430, the intelligence system, the surveillance system, and/or the user may perform an investigation to determine whether the target is associated with other known targets or whether the target is of interest. At block 434, the intelligence system, the surveillance system, and/or the user may perform or initiate a convoy search with adjusted intervals, narrower search criteria, and/or adjusted search criteria. At block 436, the intelligence system, the surveillance system, and/or the user may search for narrower correlations.

In another embodiment, FIG. 4B illustrates method 401. At block 438, an intelligence system and/or a surveillance system may capture a visual identifier. At block 440, the intelligence system and/or the surveillance system may associate the visual identifier with a target. At block 442, the intelligence system and/or the surveillance system may capture an electronic signal. At block 444, the intelligence system and/or the surveillance system may associate the electronics signal with a target. At block 446, the intelligence system and/or the surveillance system may filter the electronic signal in view of non-unique characteristics. Based on such a filter, at block 448, the intelligence system and/or the surveillance system may develop an electronic signature for an associated target. At block 450, the intelligence system and/or the surveillance system may correlate the visual identifier with the electronic signature for the associated target.

The foregoing description generally illustrates and describes various embodiments of the present disclosure. It will, however, be understood by those skilled in the art that various changes and modifications can be made to the above-discussed construction of the present disclosure without departing from the spirit and scope of the disclosure as disclosed herein, and that it is intended that all matter contained in the above description or shown in the accompanying drawings shall be interpreted as being illustrative, and not to be taken in a limiting sense. Furthermore, the scope of the present disclosure shall be construed to cover various modifications, combinations, additions, alterations, etc., above and to the above-described embodiments, which shall be considered to be within the scope of the present disclosure. Accordingly, various features and characteristics of the present disclosure as discussed herein may be selectively interchanged and applied to other illustrated and non-illustrated embodiments of the disclosure, and numerous variations, modifications, and additions further can be made thereto without departing from the spirit and scope of the present invention as set forth in the appended claims.

1. A surveillance system, comprising:
a plurality of collection systems positioned at selected geographic areas, each comprising:
one or more sensors configured to capture visual identifiers for each of a plurality of targets; and
one or more sensors configured to capture electronic signals associated with the plurality of targets; and
an intelligence system in communication with each of the plurality of collection systems, the intelligence system including a correlation and search engine configured to:
receive captured visual identifiers for each target of the plurality of targets, and captured electronic signals associated with each target of the plurality of targets from each of the plurality of collection systems;
filter the captured electronic signals associated with each target in view of one or more non-unique characteristics of the captured electronic signals and develop at least one electronic signature associated with each target;
correlate the captured visual identifiers for each target with at least one electronic signature associated with the target; and
generate an identification of one or more unknown targets based prior known factors associated with the target; determine a location of a selected target, an association of the selected target to one or more persons, association of the target to one or more locations, travel patterns of the selected target, or combinations thereof; or combinations thereof.

2. The surveillance system of claim 1, wherein at least some of the sensors of the one or more sensors configured to capture visual identifiers for each of the plurality of targets comprise an automated license plate reader positioned at one or more of the selected locations.

3. The surveillance system of claim 1, wherein the intelligence system is further configured to track one or more targets of interest using updated real-time captures of the visual identifiers of the one or more targets of interest or the one or more electronic signatures associated targets at selected locations by additional ones of the one or more collection systems.

4. The surveillance system of claim 1, wherein each of the one or more collection systems comprise a sensor assembly, including an array of sensors each configured to detect and capture one or more electronic signals associated with the plurality of targets.

5. The surveillance system of claim 4, wherein the array of sensors includes one or more of a Bluetooth® antenna, a Wi-fi antenna, a RFID antenna, or other RF antenna.

6. The surveillance system of claim 1, wherein at least some of the sensors of the one or more sensors configured to capture visual identifiers for each of the plurality of targets comprise one or more cameras configured to capture at least one of a plurality of vehicle identifiers of the plurality of targets.

7. The surveillance system of claim 6, wherein the visual identifiers include one or more of license plates, stickers, patterns, position(s) of component parts, after-market added parts, damage, or combinations thereof, of a vehicle.

8. The surveillance system of claim 1, wherein the non-unique characteristics comprise a frequency of occurrence, relative representation, signal type, signal receipt location diversity, and signal strength profiling, and wherein filtering the captured electronic signals associated with each target in view of the one or more non-unique characteristics of the captured electronic signals further comprises determining whether a relative certainty value that the captured electronic signals is associated with the target exceed a prescribed threshold in view of the non-unique characteristics.

9. The surveillance system of claim 1, wherein the intelligence system further comprises a user interface configured to display one or more of visual identifiers and electronic signatures associated with each of the identified targets of interest, relationships between the identified targets of interest and one or more electronic devices associated with the electronic signatures, or routes or predicted routes of the targets of interest.

10. The system of claim 1, wherein one or more of the collection systems are configured to analyze a signal value of each captured electronic signal, a strength of each captured electronic signal, a spectrum of each captured electronic signal, embedded identification data of each captured electronic signal, or combinations thereof; determine whether each of the captured electronic signals are from likely-unrelated sources; and if one or more of the captured electronic signals are determined to be from likely-unrelated sources, filter out the one or more captured electronic signals.

11. The system of claim 1, wherein the intelligence system is configured to prioritize one or more of the captured electronic signals for identification of a selected target.

12. A method, comprising:
capturing, in real-time via a plurality of collection systems, at least one visual identifier and associating the at least one visual identifier with a target;
capturing a plurality of electronic signals identified with a plurality of electronic devices and associating one or more of the electronic devices with the target;
filtering the captured electronic signals of the one or more electronic devices associated with each target in view of one or more non-unique characteristics of the captured electronic signals and developing at least one electronic signature for at least one electronic device associated with each target;
correlating the captured at least one visual identifier associated with the target with the at least one electronic signature associated with each target;
identifying one or more unknown targets based on the at least one visual identifier associated with each of the one or more unknown targets, the at least one electronic signature associated with each of the one or more unknown targets, or a combination thereof, and one or more prior known factors associated with the target; and
tracking one or more targets of interest based on real-time updated captures associated with the one or more targets of interest.

13. The method of claim 12, wherein the real-time captures associated with the one or more targets of interest include updated captures of the visual identifiers and electronic signatures from electronic devices associated with the one or more targets of interest at successive times and locations.

14. The method of claim 12, further comprising comparing the captured visual identifiers associated with the target of interest with identifying information for known targets of interest; and wherein tracking the one or more targets of interest comprises collecting one or more of the visual identifiers, electronic signatures, or a combination thereof, associated with the target of interest at a series of collection stations positioned at selected locations throughout a geographic area, and plotting movement of the target of interest throughout the geographic area.

15. The method of claim 14, wherein the identifying information for known targets of interest includes vehicle identifiers comprising one or more of a license plate number, stickers, patterns, position(s) of component parts, after-market added parts, damage, other markings, or combinations thereof.

16. The method of claim 13, wherein the non-unique characteristics comprise a frequency of occurrence, relative representation, signal type, signal receipt location diversity, and signal strength profiling, and wherein filtering the captured electronic signals associated with each target in view of the one or more non-unique characteristics of the captured electronic signals further comprises determining whether a relative certainty value exceeds a prescribed threshold, wherein the relative certainty value is based on determination of one or more captured electronic signals being associated with the identified target of interest in view of the non-unique characteristics.

17. The method of claim 12, further comprising displaying, via a user interface in communication with an intelligence system, the associations between the one or more of the plurality of targets and the one or more of the plurality of electronic devices.

18. The method of claim 12, wherein filtering the captured electronic signals in view of one or more non-unique characteristics of the captured electronic signals comprises analyzing a signal value of each captured electronic signal, strength of each captured electronic signal, a spectrum of each captured electronic signal, embedded identification data of each captured electronic signal, or combinations thereof, and determining whether each of the captured electronic signals are from likely-unrelated sources.

19. The method of claim 18, wherein filtering the captured electronic signals in view of one or more non-unique characteristics of the captured electronic signals is conducted at one or more of the collection systems.

20. The method of claim 12, wherein tracking the one or more targets of interest comprises determining a location of a selected target, an association of the selected target to one or more persons, association of the target to one or more locations, travel patterns of the selected target, or combinations thereof.
